(19) United States
(12) Patent Application Publication
(10) Pub. No.: US 2025/0327508 A1
(43) Pub. Date: Oct. 23, 2025

(54) CONNECTOR FOR A BALL CHAIN AND A BALL CHAIN ASSEMBLY

(71) Applicant: Ball Chain Manufacturing Co., Inc., Mount Vernon, NY (US)

(72) Inventors: William F. Taubner, Pelham Manor, NY (US); Valentine J. Taubner, III, Pelham Manor, NY (US); Valentine J. Taubner, JR., Pelham Manor, NY (US)

(21) Appl. No.: 19/185,772

(22) Filed: Apr. 22, 2025

Related U.S. Application Data
(60) Provisional application No. 63/637,752, filed on Apr. 23, 2024.

(51) Int. Cl. F16G 15/02; F16G 13/00

(52) U.S. Cl. CPC F16G 15/02; F16G 13/00

(57) ABSTRACT

A connector for a ball chain includes an arcuate bottom portion having a longitudinal centerline axis extending from a first end to a second end, a first ear extending from the arcuate bottom portion and inward towards the longitudinal centerline axis, and a second ear extending from the arcuate bottom portion, opposite the first ear laterally across the longitudinal centerline axis. The connector having a plurality of configurations, a first being an unsecured configuration, in which the first ear extends from the arcuate bottom portion inward towards the longitudinal centerline axis and the second ear extends from the arcuate bottom portion substantially perpendicular to the longitudinal centerline axis, and a second being a secured configuration, in which the second ear is folded inward towards the first ear and the longitudinal centerline axis in order to overlap the first ear and to secure a ball of the ball chain.

### CROSS REFERENCE TO RELATED APPLICATIONS

This application claims the benefit of priority of U.S. Provisional Patent Application No. 63/637,752, filed on Apr. 23, 2024, the contents of which is hereby incorporated by reference in its entirety.

### TECHNICAL FIELD

The present disclosure relates generally to a connector. More particularly, the present disclosure relates to connectors for chains, such as ball chains or bead chains.

### BACKGROUND

A ball chain or a bead chain is a type of chain formed of a series of small balls or spheres connected via a length of wire. Ball chains are employed in various industries for a variety of applications, such as, but not limited to pull cords (e.g., for light fixtures, ceiling fans, or window shades), retaining chains (e.g., for counter pens and dog tag chains), keychains, and jewelry, among others. Ball chain connectors are utilized to connect ends of a ball chain together or to connect one ball chain with another ball chain.

### BRIEF DESCRIPTION OF THE DRAWINGS

Features and advantages will be apparent from the following, more particular, description of various exemplary embodiments, as illustrated in the accompanying drawings, wherein like reference numbers generally indicate identical, functionally similar, and/or structurally similar elements.

FIG. 1 is a lateral perspective view of a ball chain connector in an unsecured configuration, according to the present disclosure.

FIG. 2 is a longitudinal, axial view of the ball chain connector of FIG. 1.

FIG. 3 is a front elevational view of the ball chain connector of FIG. 1.

FIG. 4 is a lateral perspective view of the ball chain of FIG. 1 in a secured configuration, according to the present disclosure.

FIG. 5 is a longitudinal, axial view of the ball chain connector of FIG. 4.

FIG. 6 is a front elevational view of the ball chain connector of FIG. 4.

FIG. 7 is a lateral, partial perspective view of a ball chain assembly, with a connector thereof in an unsecured configuration, according to the present disclosure.

FIG. 8 is a lateral, partial perspective view of the ball chain assembly of FIG. 7, with ends of a ball chain thereof received within the connector in the unsecured configuration.

FIG. 9 is a lateral, partial perspective view of the ball chain assembly of FIGS. 7 and 8, with the connector thereof in a secured configuration.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

As used herein, the terms “first,” “second,” “third,” “fourth,” etc., may be used interchangeably to distinguish one component from another and are not intended to signify location or importance of the individual components.

The singular forms “a,” “an,” and “the” include plural references unless the context clearly dictates otherwise.

The terms “coupled,” “fixed,” “attached,” “connected,” “coupling,” “connection,” “connector,” and the like, refer to both direct coupling, fixing, attaching, or connecting, as well as indirect coupling, fixing, attaching, or connecting through one or more intermediate components or features, unless otherwise specified herein. The terms include integral and unitary configurations.

As used herein, the terms “fixedly” or “permanently,” e.g., “fixedly secured” or “permanently attached,” refer to a connection or coupling between components in which a component is not easily detached, decoupled, or otherwise removed from another component. For example, a component may be fixedly secured to another component if the component may not be detached from the other component without use of tools, excessive force, or permanent deformation of one or both components.

As used herein, the terms “axial” and “axially” refer to directions and orientations that extend substantially parallel to a longitudinal centerline axis of a connector. Moreover, the terms “radial” and “radially” refer to directions and orientations that extend substantially perpendicular to the longitudinal centerline axis of the connector. In addition, as used herein, the terms “circumferential” and “circumferentially” refer to directions and orientations that extend arcuately about the longitudinal centerline axis of the connector.

Approximating language, as used herein throughout the specification and claims, is applied to modify any quantitative representation that could permissibly vary without resulting in a change in the basic function to which it is related. Accordingly, a value modified by a term or terms, such as “about” and “substantially” is not to be limited to the precise value specified. In at least some instances, the approximating language may correspond to the precision of an instrument for measuring the value, or the precision of the methods, or the machines for constructing the components, and/or the systems or manufacturing the components and/or the systems.

As used herein, the term “about,” as modifying a value, refers to plus or minus five percent (5%) a value that the term precedes, unless otherwise specified.

As also as used herein, unless otherwise limited or defined, “substantially perpendicular” indicates a direction that perpendicular to within plus or minus ten (10) degrees of a reference direction (e.g., within plus or minus six (6) degrees or plus or minus three (3) degrees), inclusive.

As used herein, unless otherwise limited or defined, “substantially the same” indicates a value that is within plus or minus five percent (5%) of a reference value (e.g., within plus or minus three percent (3%)), inclusive.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

Ball chains or bead chains are utilized in many industries for various applications. As one particular example, ball chains are commonly utilized in window coverings (i.e., window shades or window blinds). For example, ball chains may be pulled by a user in one of two directions to horizontally move or vertically lift the window covering or to adjust pitch angles of individual components (e.g., blinds) that collectively form the widow covering. In some applications, one ball chain may be coupled or connected to another ball chain to form a longer ball chain. In other applications, one end of a ball chain may be coupled or connected to another end of the same ball chain to form a continuous loop ball chain. In either application, a ball chain connector is used to couple or connect one ball of a ball chain with another ball (that may be of the same ball chain or of a different ball chain).

Conventional ball chain connectors allow for insertion and removal of the ball of the ball chain by a user, such that the ball chain is detachable or removable from the ball chain connector. This allows the user to remove the ball chain connector from the ball chain at any time after initial installation of the ball chain connector to the ball chain. However, the ball chain may inadvertently detach or decouple from such conventional ball chain connectors if the ball chain connector is not properly reattached or reassembled to the ball chain by the user. Further, in some applications, a ball chain connector may need to be permanently or fixedly assembled or installed to a ball chain, such that, once the ball chain connector is initially assembled or installed to the ball chain, the ball chain connector may be detached or decoupled from the ball chain only through the use of specialized tools, excessive force, or otherwise breaking the ball chain connector. For example, in some applications, a ball chain connector may need to comply with one or more industry safety standards, e.g., American National Standards Institute (ANSI)/Window Covering Manufacturers Association (WCMA) A 100.1-2022 (“American National Standard for Safety of Window Covering Products,” 2022).

Accordingly, the present disclosure provides for a connector for one or more chains (e.g., ball chains) that is configured such that the connector, once assembled with the ball chain, cannot be detached from the ball chain during the normal course of use of the ball chain assembly or by a user who does not have the necessary tools. For example, in applications with a connector of the present disclosure being utilized to form a ball chain assembly, such as a continuous loop ball chain for a window covering, the ball chain cannot be detached or decoupled from the connector except with excessive force or use of tools. This aspect of a connector of the present disclosure can provide a safety feature for ball chain assemblies (e.g., of various window coverings that must comply with applicable industry safety standards).

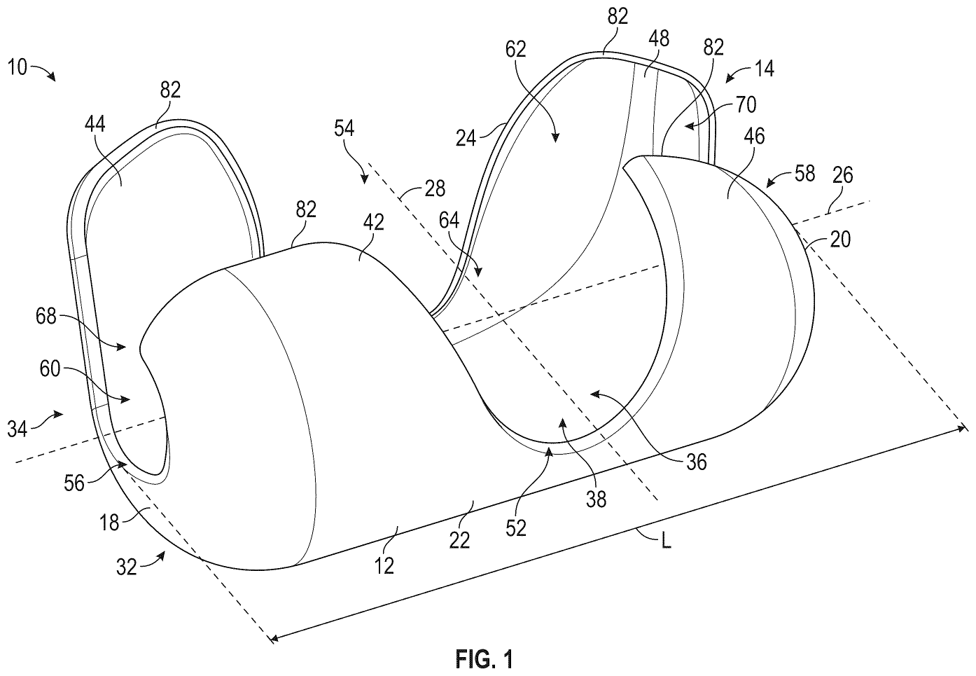

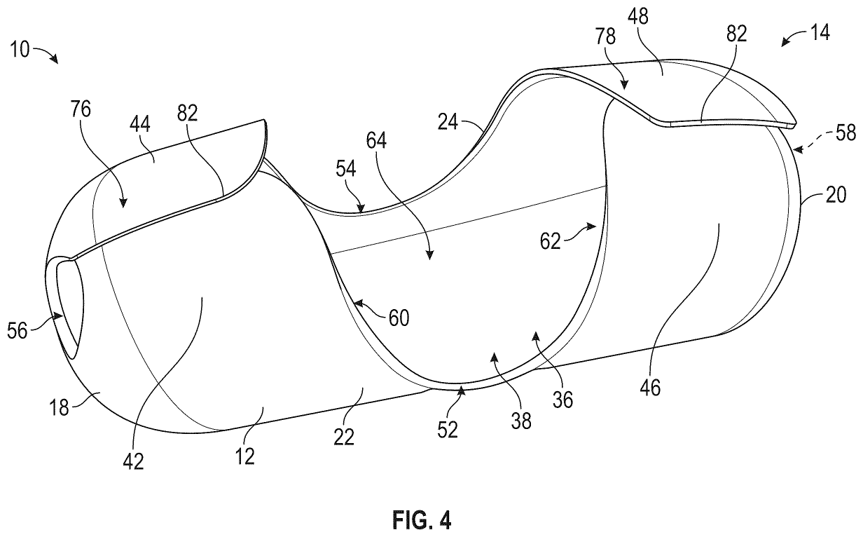

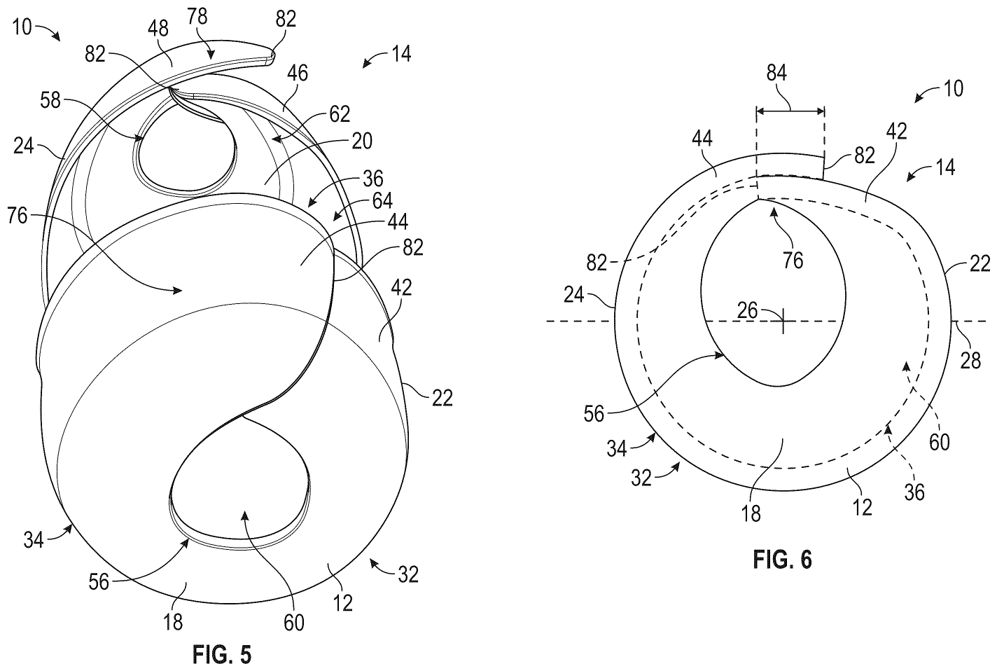

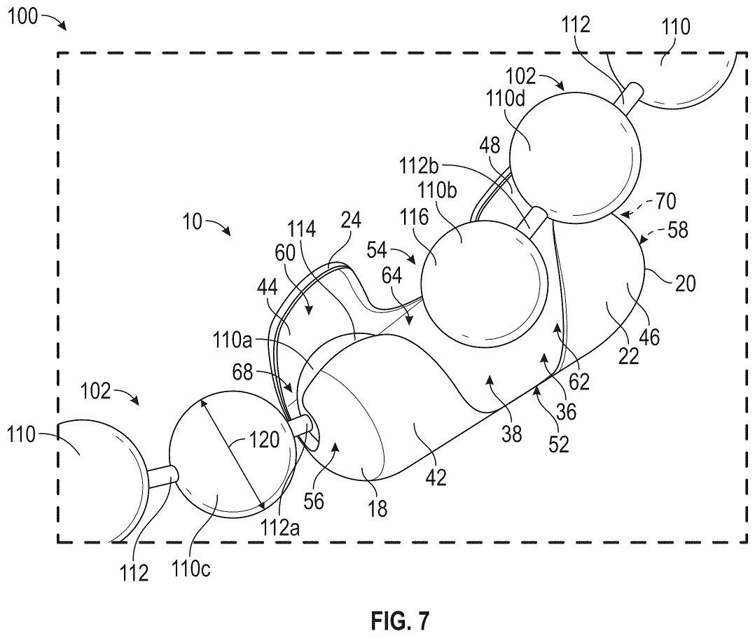

Referring now to the figures, FIGS. 1 to 6 illustrate a connector 10 according to the present disclosure. The connector 10 may also be referred to as a chain connector (e.g., a ball chain connector) or a crimp connector. As described in more detail below, the connector 10 is movable from a first or unsecured configuration (as shown in FIGS. 1 to 3), in which at least one ball of a ball chain (see FIGS. 7 to 9) is removably received by the connector 10, to a second or secured configuration (as shown in FIGS. 4 to 6), in which the at least one ball of the ball chain (see FIGS. 7 to 9) is secured to the connector 10. In some embodiments, with the connector 10 in the secured configuration, the at least one ball of the ball chain may be fixedly secured or permanently attached to the connector 10.

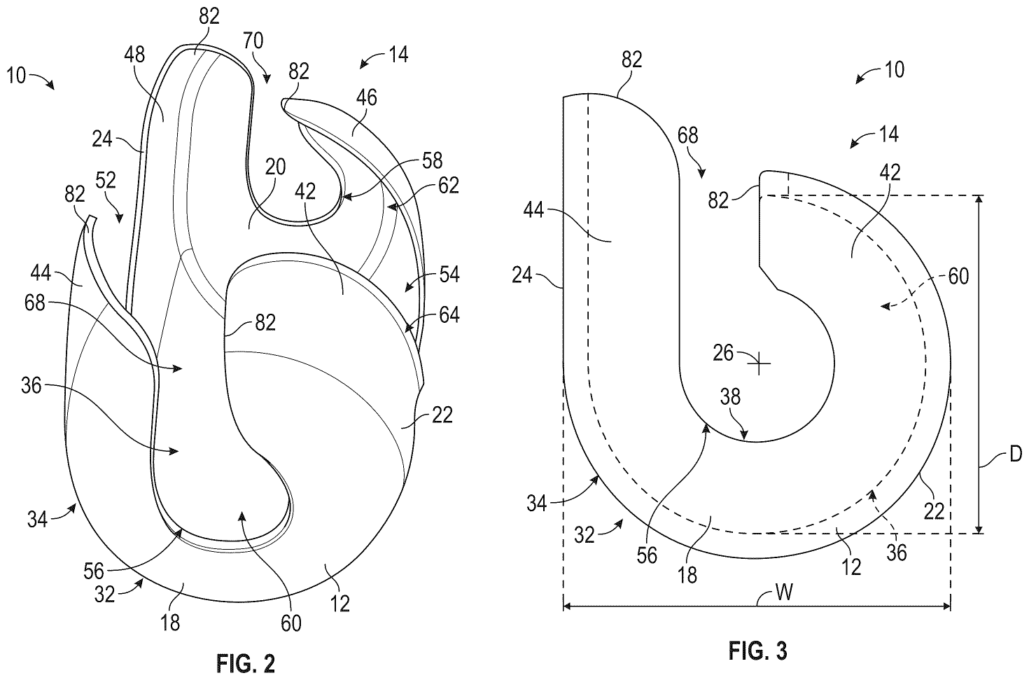

Referring to FIGS. 1 to 3, the connector 10 includes an arcuate bottom portion 12 and a plurality of extensions or ears 14 extending from the arcuate bottom portion 12. With the connector 10 in the unsecured configuration (as shown in FIGS. 1 to 3), the arcuate bottom portion 12 has a generally cylindrical shape with a first end 18, a second end 20 (FIGS. 1 and 2), opposite the first end 18, a first lateral side 22, and a second lateral side 24, opposite the first lateral side 22. A longitudinal centerline axis 26 (FIG. 1) extends through the first end 18 and the second end 20. A lateral axis 28 (FIG. 1) extends perpendicular to the longitudinal centerline axis 26 in the direction from the first lateral side 22 to the second lateral side 24.

The arcuate bottom portion 12 has a lower bottom portion 32 and an upper bottom portion 34, opposite the lower bottom portion 32, that extends from the lower bottom portion 32. In the illustrated embodiment, the lower bottom portion 32 defines a connector cavity 36 of the arcuate bottom portion 12 and the upper bottom portion 34 defines a connector opening 38 of the connector cavity 36. The arcuate bottom portion 12 defines a length L (FIG. 1) of the connector 10 in the direction of the longitudinal centerline axis 26 and extending between the first end 18 and the second end 20. Further, the arcuate bottom portion 12 defines a width W (FIG. 3) of the connector 10 in the direction of the lateral axis 28 and extending between an outermost surface on the first lateral side 22 and an outermost surface on the second lateral side 24. Each of the length L (FIG. 1) and the width W (FIG. 3) of the arcuate bottom portion 12 define the longest dimension of the connector 10 in their respective directions. In the illustrated embodiment, the longitudinal centerline axis 26 is defined at a midpoint of the width W and the lateral axis 28 is defined at a midpoint of the length L.

The plurality of ears 14 extends outwardly from the upper bottom portion 34 of the arcuate bottom portion 12 adjacent to the connector opening 38. In the illustrated embodiment, the plurality of ears 14 includes a first ear 42, a second ear 44, a third ear 46, and a fourth ear 48. In some embodiments, the plurality of ears 14 of the connector 10 may include only the first ear 42 and the second ear 44. In some embodiments, the plurality of ears 14 of the connector 10 may include six or more ears.

The first ear 42 extends from the upper bottom portion 34 along the first lateral side 22 at the first end 18, and the second ear 44 extends from the upper bottom portion 34 along the second lateral side 24 at the first end 18. The third ear 46 extends from the upper bottom portion 34 along the first lateral side 22 at the second end 20, and the fourth ear 48 extends from the upper bottom portion 34 along the second lateral side 24 at the second end 20. In other words, the first ear 42 is disposed laterally opposite the second ear 44 relative to the longitudinal centerline axis 26, and the third ear 46 is disposed laterally opposite the fourth ear 48 relative to the longitudinal centerline axis 26. Further, the first ear 42 is disposed longitudinally opposite the third ear 46 relative to the lateral axis 28 and the second ear 44 is disposed longitudinally opposite the fourth ear 48 relative to the lateral axis 28. Thus, in the illustrated embodiment, the connector 10 is substantially symmetrical about the lateral axis 28.

The first ear 42 is axially spaced from the third ear 46 along the longitudinal centerline axis 26 such that a first lateral opening 52 is defined between the first ear 42 and the third ear 46 along the first lateral side 22. Likewise, the second ear 44 is axially spaced from the fourth ear 48 along the longitudinal centerline axis 26 such that a second lateral opening 54 is defined between the second ear 44 and the fourth ear 48 along the second lateral side 24. In the illustrated embodiment, the first lateral opening 52 and the second lateral opening 54 are curved openings.

The first ear 42 is laterally spaced from the second ear 44 along the lateral axis 28 such that the first ear 42 and the second ear 44 define a first end opening 56 at the first end 18. Likewise, the third ear 46 is laterally spaced from the fourth ear 48 along the lateral axis 28 such that the third ear 46 and the fourth ear 48 define a second end opening 58 at the second end 20. In the illustrated embodiment, the first end opening 56 and the second end opening 58 are elliptical shaped openings. As shown in FIG. 3, the first end opening 56 and the second end opening 58 are substantially aligned with the longitudinal centerline axis 26. Thus, the first end opening 56 is substantially aligned with the second end opening 58.

The first end 18, a portion of the first lateral side 22, a portion of the second lateral side 24, the first ear 42, and the second ear 44 collectively define a first cavity portion 60 of the connector cavity 36 that is disposed adjacent to the first end 18 and the first end opening 56. Likewise, the second end 20, another portion of the first lateral side 22, another portion of the second lateral side 24, the third ear 46, and the fourth ear 48 collectively define a second cavity portion 62 of the connector cavity 36 that is disposed adjacent to the second end 20 and the second end opening 58. Further, another portion of the first lateral side 22 and another portion of the second lateral side 24 of the arcuate bottom portion 12 define a third cavity portion 64 of the connector cavity 36 that is disposed between the first cavity portion 60 and the second cavity portion 62 and adjacent to both the first lateral opening 52 and the second lateral opening 54.

With the connector 10 in the unsecured configuration (as shown in FIGS. 1 and 2), the plurality of ears 14 is shaped such the first ear 42 and the third ear 46 extend from the upper bottom portion 34 and inwards towards the longitudinal centerline axis 26. Particularly, as best shown in FIG. 3, with the connector 10 in the unsecured configuration, the first ear 42 and the third ear 46 each have a cross-sectional profile that is C-shaped. Further, the second ear 44 and the fourth ear 48 extend outward from the upper bottom portion 34 and away from the longitudinal centerline axis 26 (i.e., in a direction substantially perpendicular to the longitudinal centerline axis 26 and to the lateral axis 28). In this way, the first ear 42 and the second ear 44 define a first end gap 68 extending from the first end opening 56, and the third ear 46 and the fourth ear 48 define a second end gap 70 extending from the second end opening 58.

Referring to FIGS. 4 to 6, from the unsecured configuration (as shown in FIGS. 1 to 3), the connector 10 is moved to the secured configuration by bending, folding, or crimping (all terms employed interchangeably herein) the second ear 44 and the fourth ear 48 inward towards the longitudinal centerline axis 26. Particularly, the second ear 44 and the fourth ear 48 are moved radially inwards toward the first ear 42 and the third ear 46, respectively, (i.e., and towards the longitudinal centerline axis 26). In other words, top ends 82 of the second ear 44 and the fourth ear 48 are moved inwards toward the first lateral side 22 of the arcuate bottom portion 12 and contact the first ear 42 and the third ear 46, respectively.

Referring to FIG. 4, with the connector 10 in the secured configuration (as shown in FIGS. 4 to 6), the second ear 44 overlaps with the first ear 42 at a first overlap area 76 such that the first end gap 68 (FIGS. 1 and 2) is closed, and the fourth ear 48 overlaps with the third ear 46 at a second overlap area 78 such that the second end gap 70 (FIGS. 1 and 2) is closed. Further, the first lateral opening 52 is disposed adjacent to the second lateral opening 54 between the first overlap area 76 and the second overlap area 78. In other words, with the connector 10 in the secured configuration (as shown in FIGS. 4 to 6), the first cavity portion 60 is at least partially enclosed by the first ear 42 and the second ear 44 (i.e., including the first overlap area 76), the second cavity portion 62 is at least partially enclosed by the third ear 46 and the fourth ear 48 (i.e., including the second overlap area 78), and the third cavity portion 64 is open via the first lateral opening 52 and the second lateral opening 54.

As shown in FIG. 6, the second ear 44 overlaps the first ear 42 by a first overlap distance 84 of the first overlap area 76, as measured along the lateral axis 28 from the top end 82 of the first ear 42 to the top end 82 of the second ear 44. Likewise, the fourth ear 48 overlaps the third ear 46 by a second overlap distance (not shown) of the second overlap area 78, as measured along the lateral axis 28 from the top end 82 of the third ear 46 to the top end 82 of the fourth ear 48. In the illustrated embodiment, the first overlap distance 84 of the first overlap area 76 is substantially the same as the second overlap distance (not shown) of the second overlap area 78. In some embodiments, the first overlap distance 84 of the first overlap area 76 (and the second overlap distance of the second overlap area 78) is in a range of about 0.03 inches (in.) to about 0.10 in., in a range of about 0.04 in. to about 0.08 in., or in a range of about 0.05 in. to about 0.07 in. In some embodiments, the overlap distance 84 of the first overlap area 76 (and the second overlap distance of the second overlap area 78) is about 0.0625 in. (i.e., about one sixteenth ( 1/16th) of an inch). In some embodiments, the overlap distance 84 of the first overlap area 76 (and the second overlap distance of the second overlap area 78) is greater than or less than about 0.0625 in.

Although the connector 10 in the secured configuration is shown in FIGS. 4 to 6 with the second ear 44 extending over the first ear 42 and the fourth ear 48 extending over the third ear 46, the connector 10 may be configured differently. For example, in some embodiments, the first ear 42 may extend over the second ear 44 and the third ear 46 may extend over the fourth ear 48. In some embodiments, the connector 10 may not be substantially symmetrical about the lateral axis 28 (FIG. 6) when in the secured configuration. For example, in some such embodiments, the second ear 44 may extend over the first ear 42 and the third ear 46 may extend over the fourth ear 48 or the first ear 42 may extend over the second ear 44 and the fourth ear 48 may extend over the third ear 46.

As mentioned above, the connector 10 may be utilized to form a ball chain assembly by securing or attaching at least one ball of a ball chain to the connector 10. In this regard, FIGS. 7 to 9 illustrate a ball chain assembly 100 that includes a ball chain 102 (also known as a bead chain) and the connector 10 of FIGS. 1 to 6. In the illustrated embodiment, the ball chain 102 of the ball chain assembly 100 includes a plurality of balls 110 arranged in series and interconnected via a wire 112. The ball chain 102 has a first chain end 114 defined by a first ball 110a of the plurality of balls 110 and a second chain end 116, opposite the first chain end 114, defined by a second ball 110b of the plurality of balls 110. Thus, in the illustrated embodiment, the connector 10 is utilized to assemble the ball chain 102 in a continuous loop by securing the first chain end 114 adjacent to the second chain end 116. In some embodiments, the connector 10 can be utilized to form a ball chain assembly formed of a first ball chain and a second ball chain with a first chain end of the first ball chain (e.g., the first chain end 114) being secured adjacent to a first chain end of the second ball chain (e.g., the second chain end 116).

As shown in FIG. 7, with the connector 10 in the unsecured configuration (as also shown in FIGS. 1 to 3), the first ball 110a of the ball chain 102 is inserted into the third cavity portion 64 of the connector cavity 36 of the connector 10 via the connector opening 38 and then removably received within the first cavity portion 60 of the connector cavity 36 with the wire 112 being received by first end opening 56. Particularly, a first wire portion 112a of the wire 112 connecting the first ball 110a and a third ball 110c of the ball chain 102 disposed directly adjacent to the first ball 110a is inserted into the first end opening 56 of the connector 10 via the first end gap 68 defined between the first ear 42 and the second ear 44. In other words, a longitudinal centerline axis (not shown) of the ball chain 102, as defined by the wire 112, at the first chain end 114 is aligned with the longitudinal centerline axis 26 of the connector 10 when the first ball 110a is removably received within the third cavity portion 64 of the connector 10, and the ball chain 102 is pushed or pulled to secure the first ball 110a within the first cavity portion 60 under the first ear 42. In this position, the first ball 110a of the ball chain 102 is still removable from the connector 10 since the second ear 44 of the connector 10 is not crimped (as in the secured configuration of the connector 10).

With the first ball 110a of the ball chain 102 (i.e., the first chain end 114) removably received within the first cavity portion 60 of the connector 10, the second ball 110b of the ball chain 102 can be inserted into the third cavity portion 64 of the connector cavity 36 of the connector 10 via the connector opening 38 and then removably received within the second cavity portion 62 of the connector cavity 36 with the wire 112 being received by second end opening 58. Particularly, a second wire portion 112b of the wire 112 connecting the second ball 110b and a fourth ball 110d of the ball chain 102 disposed directly adjacent to the second ball 110b is inserted into the second end opening 58 of the connector 10 via the second end gap 70 defined between the third ear 46 and the fourth ear 48. In other words, the longitudinal centerline axis (not shown) of the ball chain 102, as defined by the wire 112, at the second chain end 116 is aligned with the longitudinal centerline axis 26 of the connector 10 when the second ball 110b is removably received within the third cavity portion 64 of the connector 10, and the ball chain 100 is pushed or pulled to secure the second ball 110b within the second cavity portion 62 under the third ear 46. In this position, the second ball 110b of the ball chain 102 is still removable from the connector 10 since the fourth ear 48 of the connector 10 is not crimped (as in the secured configuration of the connector 10). In some cases, the second ball 110b of the ball chain 102 can be removably received by the connector 10 before the first ball 110a of the ball chain 102.

In the illustrated embodiment, the connector opening 38 of the arcuate bottom portion 12 of the connector 10 is sized such that only one of the first ball 110a or the second ball 110b of the ball chain 102 can be received at one time. This configuration can be particularly beneficial in reducing or minimizing the length L (FIG. 1) of the connector 10 and thus also an overall weight of the connector 10. In some embodiments, the connector opening 38 of the connector 10 may be sized to simultaneously receive the first ball 110a and the second ball 110b of the ball chain 102.

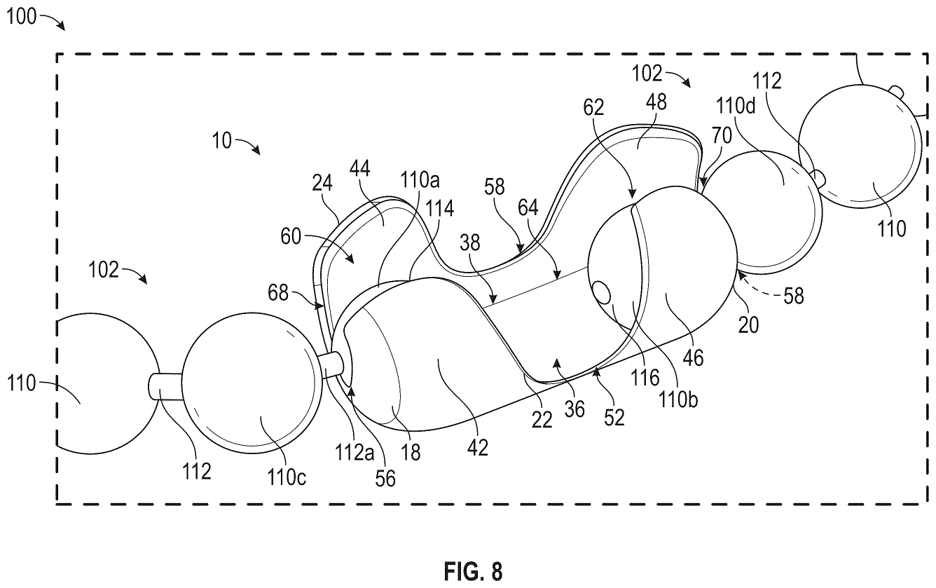

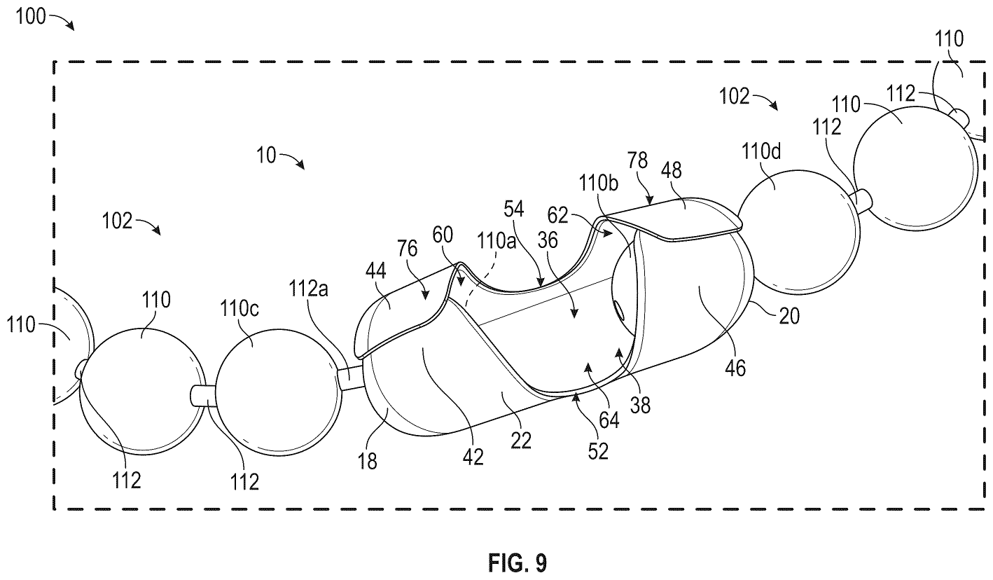

As shown in FIG. 8, with the first ball 110a of the ball chain 102 (i.e., the first chain end 114) removably received within the first cavity portion 60 of the connector 10 and the second ball 110b of the ball chain 102 (i.e., the second chain end 116) removably received within the second cavity portion 62 of the connector 10, the first chain end 114 and the second chain end 116 are removably secured by the connector 10. In other words, the first ball 110a and the second ball 110b of the ball chain 102 can be removed from the connector 10 while the connector 10 is in the unsecured configuration (as shown in FIGS. 7 and 8). As shown in FIG. 9, with the first chain end 114 and the second chain end 116 of the ball chain 102 removably received by the connector 10 in the unsecured configuration (as shown in FIGS. 7 and 8), the connector 10 can be moved to the secured configuration (as shown in FIG. 9) in order to secure or attach (e.g., permanently or fixedly) the first chain end 114 and the second chain end 116 to the connector 10. Particularly, the second ear 44 and the fourth ear 48 are crimped or folded in a manner that overlaps the second ear 44 with the first ear 42 to form the first overlap area 76 over the first ball 110a and overlaps the fourth ear 48 with the third ear 46 to form the second overlap area 78 over the second ball 110b. A tool, such as a specially designed pliers, may be utilized by a user to crimp or fold the second ear 44 and the fourth ear 48 of the connector 10.

Accordingly, when the connector 10 is in the secured configuration with the ball chain 102 (as shown in FIG. 9), the connector 10 is fixedly secured or attached to the ball chain 102, in that the ball chain 102 may not be removed from the connector 10 by the user via their hands (as would be the case with conventional chain connectors that do not include overlap areas). This is because, when crimped, the second ear 44 and the fourth ear 48 deform or reduce a cavity diameter D (FIG. 3) of the first cavity portion 60 and the second cavity portion 62 of the connector 10 as the connector 10 is moved from the unsecured configuration to the secured configuration, which clamps or secures the first ball 110a and the second ball 110b of the ball chain 102 within the first cavity portion 60 and the second cavity portion 62, respectively, in a fitted manner. Further, the connector 10 is designed such that the first overlap area 76 and the second overlap area 78 cannot be easily detached by the user (without the use of tools, e.g., pliers, or the like). Thus, with the connector 10 in the secured configuration (as shown in FIG. 9), the connector 10 will not come detached from the ball chain 102 during continued use of the ball chain 102 or by a user without the use of tools.

Generally, the connector 10 is sized to couple or connect a ball chain or bead chain having a particular ball or bead size (e.g., a ball diameter 120 of the plurality of balls 110 of the ball chain 100 of FIG. 7) or two or more ball chains having varying ball sizes. For example, the connector 10 may be sized for a particular ball size of a ball chain (e.g., the ball diameter 120 of the plurality of balls 110 of the ball chain 100 of FIG. 7) by varying dimensions of the first cavity portion 60 and the second cavity portion 62 of the connector cavity 36 of the arcuate bottom portion 12, dimensions of the first end opening 56 and the second end opening 58 of the arcuate bottom portion 12, and/or the length L (FIG. 1) and the width W (FIG. 3) of the arcuate bottom portion 12.

In some embodiments, the connector 10 may be sized (e.g., having particular dimensions of one or more of the first cavity portion 60 and the second cavity portion 62 of the connector cavity 36, the first end opening 56 and the second end opening 58 of the arcuate bottom portion 12, and/or the length L (FIG. 1) and the width W (FIG. 3) of the arcuate bottom portion 12) to couple or connect a ball chain having a ball size (e.g., the ball diameter 120 of the plurality of balls 110 of the ball chain 100 of FIG. 7) in a range of about 0.07 inches (in.) to about 0.60 in., in a range of about 0.09 in. to about 0.40 in., in a range of about 0.15 in. to about 0.38 in., or in a range of about 0.17 in. to about 0.32 in. In some embodiments, the connector 10 may be sized to couple or connect a ball chain having a ball size of about 0.25 in. In some embodiments, the connector 10 may be sized to couple or connect a ball chain having a ball size less than about 0.32 in. In some embodiments, the connector 10 may be sized to couple or connect a ball chain having a ball size greater than about 0.17 in.

In the illustrated embodiment, the first cavity portion 60 of the connector 10 is sized to receive the first ball 110a and the second cavity portion 62 of the connector 10 is sized to receive the second ball 110b of the ball chain 102 with the first ball 110a and the second ball 110b having the same ball size (e.g., the same ball diameter 120 (FIG. 7)). In some embodiments, the first cavity portion 60 of the connector 10 may be sized to receive a first ball having a first ball size and the second cavity portion 62 of the connector 10 may be sized to receive a second ball having a second ball size that is different (e.g., greater or less) than the first ball size. In some such embodiments, the first ball size may be in a range of about 0.15 in. to about 0.38 in and the second ball size may be in a range of about 0.07 in. to about 0.60 in.

Referring again to FIG. 1, in some embodiments, the length L of the connector 10, as measured along the longitudinal centerline axis 26 from the first end 18 to the second end 20 of the arcuate bottom portion 12, is in a range of about 0.70 inches (in.) to about 1.80 in., in a range of about 0.90 in. to about 1.50 in., or in a range of about 1.05 in. to about 1.35 in. In some embodiments, the length L of the connector 10, as measured along the longitudinal centerline axis 26 from the first end 18 to the second end 20 of the arcuate bottom portion 12, is about 1.15 in. In some embodiments, the length L of the connector 10, as measured along the longitudinal centerline axis 26 from the first end 18 to the second end 20 of the arcuate bottom portion 12, is greater than 1.0 in. In some embodiments, the length L of the connector 10, as measured along the longitudinal centerline axis 26 from the first end 18 to the second end 20 of the arcuate bottom portion 12, is less than 2.0 in.

In some embodiments, at least one of the first cavity portion 60 or the second cavity portions 62 of the connector 10 may be sized to receive two or more balls of the ball chain 102, e.g., by increasing the length L of the connector 10. For example, in some such embodiments, a length of the first cavity portion 60 of the connector 10 may be sized to receive two balls (e.g., the first ball 110a and a third ball directly adjacent thereto) of the ball chain 102 and a length of the second cavity portion 62 of the connector 10 may be sized to receive two balls (e.g., the second ball 110b and a fourth ball directly adjacent thereto) of the ball chain 102.

Referring again to FIG. 3, in some embodiments, the width W of the connector 10, as measured along the lateral axis 28 from the first lateral side 22 to the second lateral side 24 of the arcuate bottom portion 12, is in a range of about 0.10 inches (in.) to about 1.0 in., in a range of about 0.15 in. to about 0.80 in., or in a range of about 0.20 in. to about 0.30 in. In some embodiments, the width W of the connector 10, as measured along the lateral axis 28 from the first lateral side 22 to the second lateral side 24 of the arcuate bottom portion 12, is about 0.25 in. In some embodiments, the width W of the connector 10, as measured along the lateral axis 28 from the first lateral side 22 to the second lateral side 24 of the arcuate bottom portion 12, is greater than about 0.20 in. In some embodiments, the width W of the connector 10, as measured along the lateral axis 28 from the first lateral side 22 to the second lateral side 24 of the arcuate bottom portion 12, is less than about 0.50 in.

The ball chain connector 10 may be formed of a variety of materials having properties such that the connector 10 can be formed into a crimped connector and sufficiently strong to ensure a permanent connection. For example, in some embodiments, the connector 10 may be formed of a metallic material, i.e., a metal or a metal alloy. Some exemplary metallic materials include bronze, copper, aluminum, carbon steel, iron materials, alloys, brass, nickel plated brass, stainless steel (e.g., a 304 stainless steel or 200 series stainless steel), or combinations thereof. For example, in some such embodiments, the connector 10 may be formed of a material comprising at least one of bronze, copper, aluminum, carbon steel, iron, brass, or stainless steel. In other embodiments, at least a portion of the connector 10 may be formed of a non-metallic material. In some embodiments, the arcuate bottom portion 12 may be formed of a first material and at least some of the plurality of ears 14 may be formed of a second material having one or more properties that differ from that of the first material. For example, in some such embodiments, the arcuate bottom portion 12, the first ear 42, and the third ear 46 may be formed of a first material and the second ear 44 and the fourth ear 48 may be formed of a second material, which may be more elastic than the first material. In some embodiments, the connector 10 may have a coating (e.g., an elastomeric polymer) applied to exterior surfaces of the connector 10 (e.g., to reduce a hardness of the connector 10 or to increase friction between the connector 10 and the ball chain 102).

The connector 10 may be formed via a variety of manufacturing processes, e.g., stamping, casting, or molding, among others. In one particular example, the connector 10 is formed via a stamping process. In some such embodiments, the stamping process may utilize progressive dies. For example, in some such embodiments, the general shape of the connector 10 (e.g., the body 12 and the plurality of ears 14) may be stamped with a first die from a sheet metal, then in a second die, the connector 10 may be curved about the longitudinal centerline axis 26 to form a general C-shape, then, in a third die, the connector 10 may be formed into the unsecured configuration (as shown in FIGS. 1 to 3). At this point, the manufacturing process may end and the connector 10 may be provided to a user in the unsecured configuration (as shown in FIGS. 1 to 3) so that the user may complete the assembly process by inserting the ball chain 100 into the connector 10 and crimping the second ear 44 and the fourth ear 48 of the connector 10 (i.e., moving the connector 10 to the secured configuration (as shown in FIGS. 4 to 6)). In some such embodiments, the connector 10 is monolithically formed (i.e., as a single, unitary piece). In some embodiments, the connector 10 may have a uniform thickness, as measured from an exterior surface to an interior surface of the connector 10.

Accordingly, the present disclosure provides for a connector for one or more chains (e.g., ball chains) that is configured such that the connector, once assembled with the ball chain, cannot be detached from the ball chain during the normal course of use of the ball chain assembly or by a user who does not have the necessary tools. For example, in applications with a connector of the present disclosure being utilized to form a ball chain assembly, such as a continuous loop ball chain for a window covering, the ball chain cannot be detached or decoupled from the connector except with excessive force or use of tools. This aspect of a connector of the present disclosure can provide a safety feature for ball chain assemblies (e.g., of various window coverings that must comply with applicable industry safety standards).

Although the present invention has been described in language specific to structural features or methodological acts, the subject matter defined in the appended claims is not necessarily limited to the specific features or acts described above. Correspondingly, in some embodiments, devices or systems disclosed herein can be utilized, manufactured, installed, etc. using methods embodying aspects of the present disclosure. Correspondingly, any description herein of particular features, capabilities, or intended purposes of a device or a system is generally intended to include disclosure of a method of using such a device or a system for the intended purposes, of a method of otherwise implementing such capabilities, of a method of manufacturing relevant components of such a device or a system (or the device or the system as a whole), and of a method of installing disclosed (or otherwise known) components to support such purposes or capabilities. Similarly, unless otherwise indicated or limited, discussion herein of any method of manufacturing or for using for a particular device or a system, including installing the device or the system, is intended to inherently include disclosure, as embodiments of the invention, of the utilized features and implemented capabilities of such a device or a system.

Further aspects are provided by the subject matter of the following clauses.

A connector for a ball chain includes an arcuate bottom portion and a plurality of ears. The arcuate bottom portion has a first end, a second end opposite the first end, and a longitudinal centerline axis extending from the first end to the second end. The plurality of ears includes a first ear extending from the arcuate bottom portion and inward towards the longitudinal centerline axis and a second ear extending from the arcuate bottom portion, opposite the first ear laterally across the longitudinal centerline axis. The connector has a plurality of configurations, a first being an unsecured configuration, in which the first ear extends from the arcuate bottom portion inward towards the longitudinal centerline axis and the second ear extends from the arcuate bottom portion substantially perpendicular to the longitudinal centerline axis, and a second being a secured configuration, in which the second ear is folded inward towards the first ear and the longitudinal centerline axis in order to overlap the first ear. A ball of the ball chain being secured to the connector by the second ear overlapping the first ear in the secured configuration.

The connector of the preceding clause, with the connector in the unsecured configuration, an end gap is defined between the first ear and the second ear, the end gap being configured to receive a wire of the ball chain.

The connector of any preceding clause, the connector being configured such that the ball of the ball chain is fixedly secured to the connector in the secured configuration.

The connector of any preceding clause, the plurality of ears further including a third ear extending from the arcuate bottom portion and inward towards the longitudinal centerline axis and a fourth ear extending from the arcuate bottom portion, opposite the third ear laterally across the longitudinal centerline axis. With the connector in the secured configuration, the third ear extends from the arcuate bottom portion inward towards the longitudinal centerline axis and the fourth ear extends from the arcuate bottom portion substantially perpendicular to the longitudinal centerline axis, and, with the connector in the secured configuration, the fourth ear is folded inward towards the third ear and the longitudinal centerline axis in order to overlap the third ear. A second ball of the ball chain being secured to the connector by the fourth ear overlapping the third ear in the secured configuration.

The connector of any preceding clause, the connector is symmetric about a lateral axis of the arcuate bottom portion that extends perpendicular to the longitudinal centerline axis between the first ear and the third ear.

The connector of any preceding clause, the connector being configured such that the second ball of the ball chain is fixedly secured to the connector in the secured configuration.

A connector for a ball chain includes an arcuate bottom portion and a plurality of ears. The arcuate bottom portion has a first end, a second end opposite the first end, and a longitudinal centerline axis extending from the first end to the second end. The plurality of ears incudes a first ear extending from a first lateral side of the arcuate bottom portion and a second ear extending from a second lateral side of the arcuate bottom portion, opposite the first lateral side. The connector is movable from an unsecured configuration, in which the first ear extends from the arcuate bottom portion and inward toward the longitudinal centerline axis and the second ear extends from the arcuate bottom portion substantially perpendicular to the longitudinal centerline axis, to a secured configuration, in which the second ear is folded inward toward the first ear and the longitudinal centerline axis such that the second ear overlaps the first ear in an overlap area. The connector is configured to secure a ball of the ball chain within the overlap area.

The connector of the preceding clause, with the connector in the unsecured configuration, an end gap is defined between the first ear and the second ear, the end gap being configured to receive a wire of the ball chain.

The connector of any preceding clause, the second ear overlaps the first ear by an overlap distance that is, as measured along a lateral axis of the arcuate bottom portion from a top end of the first ear to a top end of the second ear, about 0.0625 inches.

The connector of any preceding clause, the connector being configured such that the ball of the ball chain is fixedly secured to the connector in the secured configuration.

The connector of any preceding clause, the overlap area is a first overlap area, and the plurality of ears further includes a third ear extending from the first lateral side and a fourth ear extending from the second lateral side. With the connector in the secured configuration, the third ear extends from the arcuate bottom portion and inward toward the longitudinal centerline axis and the fourth ear extends from the arcuate bottom portion substantially perpendicular to the longitudinal centerline axis, and, with the connector in the secured configuration, the fourth ear is folded inward toward the third ear and the longitudinal centerline axis such that the fourth ear overlaps the third ear in a second overlap area. The connector is configured to secure a second ball of the ball chain within the second overlap area.

The connector of any preceding clause, with the connector in the unsecured configuration, the first ear and the second ear define an end gap configured to receive a first portion of a wire of the ball chain and the third ear and the fourth ear define another end gap configured to receive a second portion of the wire of the ball chain.

The connector of any preceding clause, the connector is symmetric about a lateral axis of the arcuate bottom portion that extends perpendicular to the longitudinal centerline axis from the first lateral side to the second lateral side.

The connector of any preceding clause, the connector is non-symmetric about a lateral axis of the arcuate bottom portion that extends perpendicular to the longitudinal centerline axis from the first lateral side to the second lateral side.

The connector of any preceding clause, the connector being configured such that the second ball of the ball chain is fixedly secured to the connector in the secured configuration.

The connector of any preceding clause, with the connector in the secured configuration, the second ear overlaps the first ear by a first overlap distance that is, as measured along a lateral axis of the arcuate bottom portion from a top end of the first ear to a top end of the second ear, about 0.0625 inches.

The connector of any preceding clause, with the connector in the secured configuration, the fourth ear overlaps the third ear by a second overlap distance that is, as measured along the lateral axis from a top end of the third ear to a top end of the fourth ear, substantially the same as the first overlap distance.

The connector of any preceding clause, the connector is monolithically formed.

The connector of any preceding clause, the connector is comprised of at least one of bronze, copper, aluminum, carbon steel, iron, brass, or stainless steel.

A connector for a ball chain includes an arcuate bottom portion and a plurality of ears. The arcuate bottom portion has a first end, a second end opposite the first end, and a longitudinal centerline axis extending from the first end to the second end. The plurality of ears includes a first ear extending from a first lateral side of the arcuate bottom portion at the first end, a second ear extending from a second lateral side of the arcuate bottom portion, opposite the first lateral side, at the first end, a third ear extending from the first lateral side of the arcuate bottom portion at the second end, and a fourth ear extending from the second lateral side of the arcuate bottom portion at the second end. The connector is movable from an unsecured configuration, in which the first ear and the third ear extend from the arcuate bottom portion and inward toward the longitudinal centerline axis and the second ear and fourth ear extend from the arcuate bottom portion substantially perpendicular to the longitudinal centerline axis, to a secured configuration, in which the second ear and the fourth ear are folded inward toward the longitudinal centerline axis such that the second ear overlaps the first ear in a first overlap area and the fourth ear overlaps the third ear in a second overlap area. The connector is configured to secure a first ball of the ball chain within the first overlap area and a second ball of the ball chain within the second overlap area.

The connector of the preceding clause, with the connector in the unsecured configuration, the first ear and the second ear define a first end gap configured to receive a first portion of a wire of the ball chain and the third ear and the fourth ear define a second end gap configured to receive a second portion of the wire of the ball chain.

The connector of any preceding clause, the connector is symmetric about a lateral axis of the arcuate bottom portion that extends perpendicular to the longitudinal centerline axis from the first lateral side to the second lateral side.

The connector of any preceding clause, a length of the connector, as measured along the longitudinal centerline axis from the first end to the second end of the arcuate bottom portion, is about 1.15 inches.

The connector of any preceding clause, a width of the connector, as measured along a lateral axis extending from the first lateral side to the second lateral side of the arcuate bottom portion, is about 0.25 inches.

The connector of any preceding clause, the connector being configured such that the first ball and the second ball of the ball chain are fixedly secured to the connector in the secured configuration.

The connector of any preceding clause, with the connector in the secured configuration, the second ear overlaps the first ear by a first overlap distance that is, as measured along a lateral axis of the arcuate bottom portion from a top end of the first ear to a top end of the second ear, in a range about 0.03 inches to about 0.10 inches.

The connector of any preceding clause, with the connector in the secured configuration, the fourth ear overlaps the third ear by a second overlap distance that is, as measured along a lateral axis of the arcuate bottom portion from a top end of the third ear to a top end of the fourth ear, substantially the same as the first overlap distance.

The connector of any preceding clause, with the connector in the secured configuration, the first overlap distance and the second overlap distance are about 0.0625 inches.

The connector of any preceding clause, the connector is monolithically formed.

The connector of any preceding clause, the connector is comprised of at least one of bronze, copper, aluminum, carbon steel, iron, brass, or stainless steel.

A ball chain assembly includes at least one ball chain and a connector. The at least one ball chain includes a plurality of balls and a wire interconnecting the plurality of balls. The at least one ball chain has a first chain end defined by a first ball of the plurality of balls and a second chain end defined by a second ball of the plurality of balls. The connector includes a arcuate bottom portion and a plurality of ears. The arcuate bottom portion has a first end, a second end opposite the first end, and a longitudinal centerline axis extending from the first end to the second end. The plurality of ear includes a first ear extending from a first lateral side of the arcuate bottom portion at the first end, a second ear extending from a second lateral side of the arcuate bottom portion, opposite the first lateral side, at the first end, a third ear extending from the first lateral side of the arcuate bottom portion at the second end, and a fourth ear extending from the second lateral side of the arcuate bottom portion at the second end. The connector is movable from an unsecured configuration, in which the first ear and the third ear extend from the arcuate bottom portion and inward toward the longitudinal centerline axis and the second ear and fourth ear extend from the arcuate bottom portion substantially perpendicular to the longitudinal centerline axis, to a secured configuration, in which the second ear and the fourth ear are folded inward toward the longitudinal centerline axis such that the second ear overlaps the first ear in a first overlap area and the fourth ear overlaps the third ear in a second overlap area. The connector is configured to secure the first ball within the first overlap area and the second ball within the second overlap area.

The ball chain assembly of the preceding clause, the first ball and the second ball of the at least one ball chain having a ball size in a range of about 0.15 inches to about 0.38 inches.

The ball chain assembly of any preceding clause, the ball size of the first ball and the second ball of the at least one ball chain is about 0.25 inches.

The ball chain assembly of any preceding clause, the at least one ball chain includes a first ball chain and a second ball chain, the first ball chain includes a first plurality of balls including the first ball and a first wire, the second ball chain includes a second plurality of balls including the second ball and a second wire.

The ball chain assembly of any preceding clause, the first ball of the first ball chain has a first ball size and the second ball of the second ball chain has a second ball size that is different than the first ball size.

The ball chain assembly of any preceding clause, the first ball of the first ball chain and the second ball of the second ball chain have a ball size in a range of about 0.15 inches to about 0.38 inches.

The ball chain assembly of any preceding clause, wherein the ball size of the first ball of the first ball chain and the second ball of the second ball chain is about 0.25 inches.

The ball chain assembly of any preceding clause, the connector being configured such that the first ball and the second ball of the at least one ball chain are fixedly secured to the connector in the secured configuration.

The ball chain assembly of any preceding clause, the connector is monolithically formed.

The ball chain assembly of any preceding clause, the connector is comprised of at least one of bronze, copper, aluminum, carbon steel, iron, brass, or stainless steel.

A method of assembling a chain assembly that includes at least one ball chain and a connector. The method includes inserting a first ball of a plurality of balls of the at least one ball chain into a connector opening of the connector, inserting a first wire portion of a wire of the at least one ball chain into a first end gap of the connector, sliding the first ball of the at least one ball chain into a first cavity portion of the connector that is at least partially defined by a first ear of a plurality of ears of the connector, inserting a second ball of the plurality of balls of the at least one ball chain into the connector opening, inserting a second wire portion of the wire of the at least one ball chain into a second end gap of the connector, and sliding the second ball of the at least one ball chain into a second cavity portion of the connector that is at least partially defined by a third ear of the plurality of ears of the connector. The method further includes crimping or folding a second ear of the plurality of ears toward a longitudinal centerline axis of the connector such that the second ear overlaps the first ear in a first overlap area, and crimping or folding a fourth ear of the plurality of ears toward the longitudinal centerline axis of the connector such that the fourth ear overlaps the third ear in a second overlap area.

The method of the preceding clause, the first ball of the ball chain being fixedly secured within the first cavity portion by the crimped first ear and the crimped second ear.

The method of any preceding clause, the second ball of the ball chain being fixedly secured within the second cavity portion by the crimped third ear and the crimped fourth ear.

The method of any preceding clause, the second ear overlaps the first ear by a first overlap distance that is, as measured along a lateral axis of the connector from a top end of the first ear to a top end of the second ear, in a range about 0.03 inches to about 0.10 inches.

The method of any preceding clause, the second ear overlaps the first ear by a first overlap distance that is, as measured along a lateral axis of the connector from the top end of the first ear to the top end of the second ear, about 0.0625 inches.

The method of any preceding clause, the fourth ear overlaps the second ear by a second overlap distance that is, as measured along the lateral axis of the connector from a top end of the third ear to a top end of the fourth ear, in a range about 0.03 inches to about 0.10 inches.

The method of any preceding clause, the fourth ear overlaps the third ear by the second overlap distance that is, as measured along the lateral axis of the connector from the top end of the third ear to the top end of the fourth ear, about 0.0625 inches.

The method of any preceding clause, the fourth ear overlaps the third ear by the second overlap distance that is, as measured along the lateral axis of the connector from the top end of the third ear to the top end of the fourth ear, substantially the same as the first overlap distance.

The method of any preceding clause, the chain assembly forming a continuous loop of the at least one ball chain.

The method of any preceding clause, the at least one ball chain includes a first ball chain and a second ball chain, the first ball chain includes a first plurality of balls including the first ball and a first wire, the second ball chain includes a second plurality of balls including the second ball and a second wire.

The method of any preceding clause, the first ball and the second ball of the at least one ball chain having a ball size in a range of about 0.15 inches to about 0.38 inches.

The method of any preceding clause, the ball size of the first ball and the second ball of the at least one ball chain is about 0.25 inches.

The method of any preceding clause, the connector being monolithically formed.

The method of any preceding clause, the connector being comprised of at least one of bronze, copper, aluminum, carbon steel, iron, brass, or stainless steel.

A method of forming a connector for a chain. The method includes forming a body having a longitudinal axis, forming a plurality of ears extending from the body, with at least one ear of the plurality of ears disposed each side of the longitudinal axis, and crimping at least one ear of the plurality of ears disposed on one side of the longitudinal axis inward toward the longitudinal axis.

The method of the preceding clause, the plurality of ears including at least two ears extending from the body on one side of the longitudinal axis and at least two ears extending from the body on another side of the longitudinal axis. The at least two ears disposed on one side of the longitudinal axis being crimped inward toward the longitudinal axis.

The method of any preceding clause, the connector being formed via a stamping process.

The method of any preceding clause, the stamping process including progressive dies.

The method of any preceding clause, the connector being monolithically formed.

The method of any preceding clause, the connector being comprised of at least one of bronze, copper, aluminum, carbon steel, iron, brass, or stainless steel.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. A connector for a ball chain, the connector comprising:
an arcuate bottom portion having a first end, a second end opposite the first end, and a longitudinal centerline axis extending from the first end to the second end, and a plurality of ears comprising a first ear extending from the arcuate bottom portion and inward towards the longitudinal centerline axis and a second ear extending from the arcuate bottom portion, opposite the first ear laterally across the longitudinal centerline axis,
wherein the connector has a plurality of configurations, a first being an unsecured configuration, in which the first ear extends from the arcuate bottom portion inward towards the longitudinal centerline axis and the second ear extends from the arcuate bottom portion substantially perpendicular to the longitudinal centerline axis, and a second being a secured configuration, in which the second ear is folded inward towards the first ear and the longitudinal centerline axis in order to overlap the first ear, a ball of the ball chain being secured to the connector by the second ear overlapping the first ear in the secured configuration.

2. The connector of claim 1, wherein, with the connector in the unsecured configuration, an end gap is defined between the first ear and the second ear, the end gap being configured to receive a wire of the ball chain.

3. The connector of claim 1, wherein the connector is comprised of at least one of bronze, copper, aluminum, carbon steel, iron, brass, or stainless steel.

4. The connector of claim 1, wherein the connector is monolithically formed.

5. The connector of claim 1, wherein the second ear overlaps the first ear by an overlap distance that is, as measured along a lateral axis of the arcuate bottom portion from a top end of the first ear to a top end of the second ear, about 0.0625 inches.

6. The connector of claim 1, wherein the plurality of ears further comprises a third ear extending from the arcuate bottom portion and inward towards the longitudinal centerline axis and a fourth ear extending from the arcuate bottom portion, opposite the third ear laterally across the longitudinal centerline axis, and
wherein, with the connector in the unsecured configuration, the third ear extends from the arcuate bottom portion inward towards the longitudinal centerline axis and the fourth ear extends from the arcuate bottom portion substantially perpendicular to the longitudinal centerline axis, and, with the connector in the secured configuration, the fourth ear is folded inward towards the third ear and the longitudinal centerline axis in order to overlap the third ear, a second ball of the ball chain being secured to the connector by the fourth ear overlapping the third ear in the secured configuration.

7. The connector of claim 6, wherein the connector is symmetric about a lateral axis of the arcuate bottom portion that extends perpendicular to the longitudinal centerline axis between the first ear and the third ear.

8. The connector of claim 6, wherein, with the connector in the secured configuration, the second ear overlaps the first ear by a first overlap distance that is, as measured along a lateral axis of the arcuate bottom portion from a top end of the first ear to a top end of the second ear, about 0.0625 inches.

9. The connector of claim 8, wherein, with the connector in the secured configuration, the fourth ear overlaps the third ear by a second overlap distance that is, as measured along the lateral axis from a top end of the third ear to a top end of the fourth ear, substantially the same as the first overlap distance.

10. A connector for a ball chain, the connector comprising:
an arcuate bottom portion having a first end, a second end opposite the first end, and a longitudinal centerline axis extending from the first end to the second end, and a plurality of ears comprising a first ear extending from the arcuate bottom portion at the first end and inward towards the longitudinal centerline axis, a second ear extending from the arcuate bottom portion at the first end, opposite the first ear laterally across the longitudinal centerline axis, a third ear extending from the arcuate bottom portion at the second end and inward towards the longitudinal centerline axis, and a fourth ear extending from the arcuate bottom portion at the second end, opposite the third ear laterally across the longitudinal centerline axis,
wherein the connector has a plurality of configurations, a first being an unsecured configuration, in which the first ear and the third ear extend from the arcuate bottom portion inward towards the longitudinal centerline axis and the second ear and the fourth ear extend from the arcuate bottom portion substantially perpendicular to the longitudinal centerline axis, and a second being a secured configuration, in which the second ear and the fourth ear are folded inward towards the longitudinal centerline axis in order to overlap the first ear and the third ear, respectively, and
wherein, with the connector in the secured configuration, a first ball of the ball chain being secured to the connector by the second ear overlapping the first ear and a second ball of the ball chain being secured to the connector by the fourth ear overlapping the third ear.

11. The connector of claim 10, wherein the connector is symmetric about a lateral axis of the arcuate bottom portion that extends perpendicular to the longitudinal centerline axis between the first ear and the third ear.

12. The connector of claim 10, wherein a length of the connector, as measured along the longitudinal centerline axis from the first end to the second end of the arcuate bottom portion, is about 1.15 inches.

13. The connector of claim 10, wherein a width of the connector, as measured along a lateral axis of the arcuate bottom portion that extends perpendicular to the longitudinal centerline axis between the first ear and the third ear, is about 0.25 inches.

14. The connector of claim 10, wherein, with the connector in the secured configuration, the second ear overlaps the first ear by a first overlap distance that is, as measured along a lateral axis of the arcuate bottom portion from a top end of the first ear to a top end of the second ear, in a range about 0.03 inches (in.) to about 0.10 in.

15. The connector of claim 14, wherein, with the connector in the secured configuration, the fourth ear overlaps the third ear by a second overlap distance that is, as measured along the lateral axis of the arcuate bottom portion from a top end of the third ear to a top end of the fourth ear, substantially the same as the first overlap distance.

16. The connector of claim 15, wherein, with the connector in the secured configuration, the first overlap distance and the second overlap distance are about 0.0625 in.

17. A ball chain assembly comprising:
at least one ball chain comprising a plurality of balls and a wire interconnecting the plurality of balls, the at least one ball chain having a first chain end defined by a first ball of the plurality of balls and a second chain end defined by a second ball of the plurality of balls; and
a connector comprising an arcuate bottom portion having a first end, a second end opposite the first end, and a longitudinal centerline axis extending from the first end to the second end, and a plurality of ears comprising a first ear extending from the arcuate bottom portion at the first end and inward towards the longitudinal centerline axis, a second ear extending from the arcuate bottom portion at the first end, opposite the first ear laterally across the longitudinal centerline axis, a third ear extending from the arcuate bottom portion at the second end and inward towards the longitudinal centerline axis, and a fourth ear extending from the arcuate bottom portion at the second end, opposite the third ear laterally across the longitudinal centerline axis,
wherein the connector has a plurality of configurations, a first being an unsecured configuration, in which the first ear and the third ear extend from the arcuate bottom portion inward towards the longitudinal centerline axis and the second ear and the fourth ear extend from the arcuate bottom portion substantially perpendicular to the longitudinal centerline axis, and a second being a secured configuration, in which the second ear and the fourth ear are folded inward towards the longitudinal centerline axis in order to overlap the first ear and the third ear, respectively, and
wherein, with the connector in the secured configuration, the first ball of the ball chain is secured to the connector by the second ear overlapping the first ear and the second ball of the ball chain is secured to the connector by the fourth ear overlapping the third ear.

18. The ball chain assembly of claim 17, wherein the at least one ball chain comprises a first ball chain and a second ball chain, the first ball chain comprising a first plurality of balls including the first ball and a first wire, the second ball chain comprising a second plurality of balls including the second ball and a second wire.

19. The ball chain assembly of claim 17, wherein the first ball and the second ball of the at least one ball chain has a ball size in a range of about 0.15 inches (in.) to about 0.38 in.

20. The ball chain assembly of claim 19, wherein the ball size of the first ball and the second ball of the at least one ball chain is about 0.25 in.

21. A connector for a ball chain, the connector comprising:
an arcuate bottom portion having a first end, a second end opposite the first end, and a longitudinal centerline axis extending from the first end to the second end; and
a plurality of ears comprising a first ear extending from the arcuate bottom portion and inward towards the longitudinal centerline axis and a second ear extending from the arcuate bottom portion, opposite the first ear laterally across the longitudinal centerline axis,
wherein, with the connector in a secured configuration, the second ear overlaps the first ear to secure a first ball of the ball chain.

22. The connector of claim 21, wherein the second ear overlaps the first ear by an overlap distance that is, as measured along a lateral axis of the arcuate bottom portion from a top end of the first ear to a top end of the second ear, about 0.0625 inches.

23. The connector of claim 21, wherein the plurality of ears further comprises a third ear extending from the arcuate bottom portion and inward towards the longitudinal centerline axis and a fourth ear extending from the arcuate bottom portion, opposite the third ear laterally across the longitudinal centerline axis, and
wherein, with the connector in the secured configuration, the fourth ear overlaps the third ear to secure a second ball of the ball chain.

24. The connector of claim 23, wherein a width of the connector, as measured along a lateral axis of the arcuate bottom portion that extends perpendicular to the longitudinal centerline axis between the first ear and the third ear, is about 0.25 inches.

25. The connector of claim 23, wherein the connector is configured such that the first ball and the second ball of the ball chain has a ball size in a range of about 0.15 inches (in.) to about 0.38 in.

26. The connector of claim 23, wherein, with the connector in the secured configuration, the second ear overlaps the first ear by a first overlap distance that is, as measured along a lateral axis of the arcuate bottom portion from a top end of the first ear to a top end of the second ear, in a range about 0.03 inches (in.) to about 0.10 in.

27. The connector of claim 26, wherein, with the connector in the secured configuration, the fourth ear overlaps the third ear by a second overlap distance that is, as measured along the lateral axis of the arcuate bottom portion from a top end of the third ear to a top end of the fourth ear, substantially the same as the first overlap distance.

28. The connector of claim 27, wherein, with the connector in the secured configuration, the first overlap distance and the second overlap distance are about 0.0625 in.
